(19) United States
(12) Patent Application Publication
(10) Pub. No.: US 2010/0146822 A1
(43) Pub. Date: Jun. 17, 2010

(54) DANCE SHOE

(76) Inventor: Elizabeth Y. MacGregor, Colwyn Bay (GB)

Correspondence Address: MICHAEL BEST & FRIEDRICH LLP, 100 E WISCONSIN AVENUE, Suite 3300, MILWAUKEE, WI, 53202, US

(21) Appl. No.: 12/519,004

(22) PCT Filed: Dec. 13, 2007
(86) PCT No.: PCT/GB2007/004790

§ 371 Date: Feb. 5, 2010

(30) Foreign Application Priority Data
Dec. 15, 2006 (GB) 0625184.7

(51) Int. Cl. A43B 23/00; A43B 5/12; G08B 21/00; G09B 19/00

(52) U.S. Cl. 36/136; 36/8.3; 340/686.1; 434/250

(57) ABSTRACT

A dance shoe, a method of detecting and signaling a predefined configuration of a dance shoe for example during dancing and the use of a detector and/or a signal means in a dance shoe is described. The dance shoe comprises a detector for detecting a configuration of the dance shoe, and a signal means operably associated with the detector so as to generate a signal upon detection of a predefined configuration by the detector. The predefined configuration is provided by a curvature of an area of the dance shoe.

### BACKGROUND

The present invention relates to a dance shoe.

In many types of dance, such as ballet and jazz dancing, it is essential for the dancer to point the toes. In order to point the toes as required, the foot must be curved or bent significantly so that the pointing of the toes reaches through the foot and to the very ends of the toes. In particular, the region of the foot from the metatarsal bones to the very ends of the toes must be curved or bent significantly. As is well known, the toes comprise a number of phalanges, the big (or first) toe comprising two phalanges and the remaining (second to fifth) toes each comprising three phalanges. The phalanges joined to the metatarsal bones are known as the proximal phalanges and those at the ends of the toes are known as the distal phalanges. Those toes comprising three phalanges also comprise a middle phalanges, joined between the proximal and distal phalanges. Thus, to attain the correct position of the foot when pointing the toes, a dancer must curve or bend the foot significantly from the metatarsal bones to the distal phalanges. When a dancer is learning to dance, the dancer often is unable to and/or does not achieve sufficient curvature and/or stretching of the foot as described above so as to attain the correct position and pointing of the toes. This problem may arise particularly when the dancer is a child.

A dance teacher must correct the position of the foot and teach the dancer how to achieve the correct position and pointing of the toes, for example by encouraging the dancer to curve and stretch the foot sufficiently (i.e. to the very ends of the toes or distal phalanges). It can, however, be difficult to make this correction, as the dancer cannot appreciate how much curving and/or stretching of the foot is required to achieve the correct position to attain the desired pointing of the toes.

Various shoes have been described previously, which incorporate one or more sensors. For example, U.S. Pat. No. 5,765,300 describes a shoe comprising at least one trigger element, which is a piezoelectric element, for producing a trigger signal when the shoe is brought into contact with the floor and flexed to a predetermined degree. A sound synthesiser circuit is coupled to each trigger element and produces an audible sound via. a speaker when a trigger signal is received. The trigger elements of the shoe of U.S. Pat. No. 5,765,300 produce the trigger signal when the shoe is kicked down against the floor. They do not detect a curvature and/or bending of the shoe.

US-2006/0032085 describes a tap dance shoe comprising one or more visual indicators in electrical communication with a battery disposed in the shoe and a pressure actuated switch mechanism, such as one or more piezoelectric sensor elements, operatively connected to the heel or toe tap of the tap dance shoe. In use, when the heel or toe tap contacts the floor so as to apply pressure, the switches complete an electrical circuit between the battery and the visual indicators to energise the visual indicators.

GB-2,353,937 describes a shoe comprising a device for monitoring a pre-selected quantity associated with the sporting activity of the wearer and a display device for displaying an indication of the level of the quantity measured. Sensors described as suitable for use in the monitoring device include sensors that use piezo technology.

In the shoes of U.S. Pat. No. 5,765,300, US-2006/0032085 and GB-2,353,937 the sensors are pressure sensors, i.e. which sense the contact of the shoe with a surface which typically is the floor. There is no disclosure in U.S. Pat. No. 5,765,300, US-2006/0032085 or GB-2,353,937 of a shoe comprising a detector for detecting a curvature and/or bending of the shoe.

Sensors that may detect bending have been described. For example, U.S. Pat. No. 5,338,891 describes an electronic musical instrument that comprises a pair of performing gloves, which gloves comprise bend sensors. The bend sensors provide signals that are converted by an A/D converter into digital flexion data that is processed by a controller and used to generate musical tones.

U.S. Pat. No. 4,937,444 describes an optical flex sensor that produces an output signal in response to bending. The flex sensor may be attached to the fabric of a glove, a body suit or an elastic bandage to electrically measure the position of joints and limbs.

U.S. Pat. No. 6,940,062 describes an optical fiber curvature sensor for measuring body motion, such as motions of fingers, arms or legs. U.S. Pat. No. 6,940,062 suggests that the sensors it describes may be useful in the animation and/or game industries.

U.S. Pat. No. 5,157,372 describes a flexible potentiometer, the electrical resistance of which consistently and predictably varies as it is bent or deflected incrementally.

None of U.S. Pat. No. 5,388,891, U.S. Pat. 4,937,444, U.S. Pat. No. 6,940,062 or U.S. Pat. No. 5,157,372 discloses a dance shoe comprising a detector for detecting a curvature and/or bending of the dance shoe and a signal means.

### SUMMARY

In one embodiment, the invention provides a dance shoe that includes a detector for detecting a configuration of the dance shoe, and a signal means operably associated with the detector so as to generate a signal upon detection of a predefined configuration by the detector. The predefined configuration is provided by a curvature of an area of the dance shoe.

The dance shoe of the present invention addresses the problems discussed above and may be used as a teaching aid. In use, once a signal is generated by the signal means, the signal indicates to the dancer that the correct foot position has been attained and the dancer may aim for this position in the future. In particular, the dance shoe generates a signal when the dancer curves and stretches the foot to the very ends of the toes, which is difficult to attain due to weakness of this area of the foot and/or a lack of understanding by the dancer of the desired position of the foot. The signal is readily observable by the dancer and a person observing the dancer (such as a dance teacher) and may accurately indicate that the correct foot position has been attained. This in turn helps to strengthen the foot (especially in the region of the metatarsal bones and/or the toes) and particularly the muscles of the sole of the foot, and helps the dancer to attain the correct foot position in the future.

By the term “dance shoe” we mean any shoe that may be used for dancing in which a curvature and/or bending of the shoe occurs and may be detected upon the dancer pointing the toes. Typically, for a curvature and/or bending to be detectable, the dance shoe must be flexible, i.e. is a shoe constructed from a material that readily allows a curving and/or bending of the foot of a wearer. In particular, the dance shoe of the present invention may be a soft-soled and/or soft-toed dance shoe, such as a ballet shoe, a jazz shoe, a soft-toed Irish dance shoe or a gymnastic shoe, especially a ballet shoe.

As the skilled person would appreciate, by the term “ballet shoe” we include a soft shoe or slipper for ballet dancing, typically made from leather, canvas and/or satin. A ballet shoe may have a split sole or a full sole construction.

The dance shoe of the present invention may adopt different positions or configurations, for example due to the flexibility of the dance shoe. The position or configuration of the dance shoe typically results from the movement of the dance shoe, such as due to the movement of the foot of a wearer of the dance shoe. In other words, a physical movement of the foot of the wearer corresponds to a movement of the dance shoe between different positions or configurations. Typically, the movement of the foot of the wearer and of the dance shoe is associated with a curvature and/or bending of the foot, such as is provided by the wearer pointing the toes. Different positions or configurations are obtainable depending on the degree and angle of curvature and/or bending of the foot of the wearer. In particular, the dance shoe of the present invention may adopt different positions or configurations provided by the bending or curving of the foot of the wearer, such as a bending or curving through the region of the metatarsal bones to the ends of the toes (or distal phalanges) of the wearer.

The predefined configuration of the dance shoe (which is detected by a detector) is provided by a curvature of an area of the dance shoe. The predefined configuration may be defined as the curvature that is provided when a dancer points the toes and attains the correct foot position, as discussed above. More particularly, the predefined configuration may be provided by a curvature typically produced (when the shoe is worn) by the dancer significantly curving and/or bending the foot (particularly in the region of the metatarsal bones and to the ends of the toes) so that the pointing of the toes reaches through the foot and to the very ends of the toes. The correct position of the foot when the toes are pointed should arrange the underside of the foot into a concave curvature (with the upper surface having a convex arrangement). Thus, in particular, the predefined configuration may be provided by a concave curvature of an area of the dance shoe. In particular, in order to achieve the desired pointing of the toes, the curving/bending of the foot occurs in the region of the metatarsal bones and continues to the ends of the toes, for example so as to provide an arching of the foot through the metatarsal bones to the very ends of the toes. It is not sufficient to simply clench the toes. A clenching of the toes would draw the toes inwards and upwards, not provide a concave curvature as desired, and therefore would not provide the predefined configuration.

Typically, the correct position attained upon the pointing of the toes results in a curving or arching (especially a concave curving) in a region of the foot which houses one or more of the metatarsal bones and continues to the very ends of the toes of a foot of a wearer, especially in the region of the third (middle) metatarsal bone to the very end of the third (middle) toe of the foot of the wearer. In other words, this curving or arching occurs in the region of the foot which houses one or more of the metatarsal bones and continues to the distal phalanges of a foot of a wearer, especially in the region of the third (middle) metatarsal bone to the third (middle) distal phalanges of the foot of the wearer. The area of the curvature (especially the concave curvature) of the dance shoe therefore typically is located in a region of the dance shoe that is curved or bent upon the pointing of the toes of a wearer, for example the area of the curvature (especially the concave curvature) may be located in a region of the shoe which covers one or more of the metatarsal bones and continues to the very ends of the toes of a foot of a wearer, especially in the region of the third (middle) metatarsal bone to the very end of the third (middle) toe of the foot of the wearer. In other words, the area of the curvature typically is located in a region of the dance shoe which covers one or more of the metatarsal bones and continues to the distal phalanges of a foot of a wearer, especially in the region of the third (middle) metatarsal bone to the third (middle) distal phalanges of the foot of the wearer. Thus, in particular the detector may be located in the region of the shoe which covers one or more of the metatarsal bones of a foot of a wearer, especially the third (middle) metatarsal bone, and continues to the very end of the toes, especially the third (middle) toe or distal phalanges, of the foot of the wearer. The detector therefore preferably is located in a region of the shoe that covers an area including the metatarsophalangeal joint (i.e. the joint between the metatarsal bone(s) and the proximal phalange(s)). As is well known in the art, the metatarsus consists of the five long (metatarsal) bones of the foot.

The dance shoe of the present invention comprises a detector for detecting a configuration of the dance shoe, including the predefined configuration as discussed above. The detector therefore detects a physical movement of the foot of a wearer of the dance shoe, which movement typically is associated with a curvature and/or bending of the foot as discussed above. In particular, the detector is arranged to detect a configuration, including a predefined configuration, of the dance shoe, which configuration is provided by a curvature of an area of the dance shoe, especially a concave curvature. Preferably, the detector is arranged to detect a bending or curving in one direction only (i.e. relative to a horizontal plane when the detector lies flat/is not bent or curved). For example, the detector preferably is arranged to detect a bending or curving of an area of the dance shoe such that an inner surface of this area forms a concave curvature. The detector is operably associated with a signal means.

As the skilled person would appreciate, the detector and the signal means conveniently are suitably sized and arranged so as to enable them to be located in the dance shoe whilst causing little or no discomfort to the wearer (i.e. the dancer) of the shoe. In other words, the detector and the signal means should be small and lightweight, so as to allow comfortable and natural movement by the wearer of the shoe. In particular, the detector and the signal means both are directly attached to the dance shoe at a suitable location. Similar considerations apply to any other optional components that may be associated with the detector and/or signal means and that are located in the dance shoe (such as a power supply and/or means for communication, as discussed herein).

References herein to the detector and the signal means (and optional other components) being located in the dance shoe are intended to include aspects wherein the aforementioned detector, signal means and optional components are each located at any suitable position, for example on the inside and/or outside, of the shoe in use. For example, the detector, signal means and optional components may be fixed to an inner and/or outer surface and/or section of the shoe by any suitable means, including sewing and/or adhering them to the shoe. The detector, signal means and optional components may be supplied pre-fixed to a dance shoe or may be supplied with means for fixing them to the shoe (and preferably with instructions as to how and/or where they should be fixed to the shoe).

The detector may be located at any suitable position in the dance shoe provided that it can act to detect the position or configuration (including the predefined configuration) of the shoe in use, for example to detect the curvature (especially a concave curvature) of an area of the dance shoe.

Thus, in particular the detector may be located in the region of the shoe which covers one or more of the metatarsal bones of a foot of a wearer, especially the third (middle) metatarsal bone, and continues to the very end of the toes, especially the third (middle) toe, of the foot of the wearer. In other words, the detector may be located in the region of the shoe which covers one or more of the metatarsal bones of a foot of a wearer, especially the third (middle) metatarsal bone, and continues to the distal phalanges, especially the third (middle) distal phalanges, of the foot of the wearer. The location of the detector in this particular region is advantageous because it allows for the detection of a specific movement of the foot and in particular the desired position or configuration as discussed above.

A soft-soled and/or soft-toed dance shoe, such as a ballet shoe, typically comprises a shoe upper and an underfoot section. The shoe upper is arranged to cover the toes and to extend along either side of the instep and around the heel of the foot of a wearer. The shoe upper comprises a front region and a rear region. The front region of the shoe upper may be defined as the region of the upper which surrounds at least a portion of the front half of the foot of the wearer, for example so as to surround the top and sides of the toes and a front part of the foot (including the metatarsus) of the wearer. The rear region of the shoe upper may be defined as the region of the upper which surrounds at least a portion of the rear half of the foot of the wearer, for example so as to surround the heel of the wearer. The underfoot section extends over the underside of the foot and may be of a full or split sole construction, such constructions being well known in the art. The underfoot section is arranged to cover the underside of the foot of a wearer and comprises a front region and a rear region. The front region of the underfoot section may be defined as the region which extends under the front of the foot and is connected with the front region of the shoe upper. The rear region of the underfoot section may be defined as the region which extends under the heel of the foot and is connected with the rear region of the shoe upper.

The detector preferably is located in the front region of the shoe upper. More particularly, the detector may be located in a central portion of the front region of the shoe upper, which central region may correspond to the area or region of the front region of the shoe upper which covers one or more of the metatarsal bones and continues to the very ends of the toes of a foot of a wearer, especially which covers the third (middle) metatarsal bone to the very end of the third (middle) toe of the foot of the wearer. The central portion of the front region of the shoe upper typically is defined by a longitudinal axis of the shoe, i.e. such that it is centered longitudinally in respect to the shoe. The detector may be attached to an outer or inner surface of the front region of the shoe upper. Preferably, the detector is attached to an inner surface of the front region of the shoe upper. This aids the sensitivity and accuracy of the detector and is more visually appealing, as the components of the detector are hidden from view when the dance shoe is worn.

In particular, the dance shoe may comprise a shoe upper and an underfoot section, the shoe upper and the underfoot section each comprising a front region and a rear region, wherein the detector is located in the front region of the shoe upper. The detector may be located in a central region of the front region of the shoe upper.

The signal means preferably is located in the front region of the shoe upper. More particularly, when the signal means is a visual signal means, one or more (such as from one to six, especially from two to four, for example three or four) light emitting diodes may be located in the front region of the shoe upper, for example in the front region where the toes of a wearer are located. Preferably, the signal means (and particularly a visual signal means such as one or more light emitting diodes) is attached to an outer surface of the front region of the shoe upper. This aids the observation of the signal (for example the observation of the light emitting diodes) by a dancer wearing the shoe.

For example, the detector may conveniently be located in the sole of the shoe (i.e. the underfoot section) or in an upper surface and/or section (i.e. the shoe upper) of the shoe when worn. Typically, the detector is positioned in the region of the shoe in which one or more of the metatarsal bones and toes of a wearer are located, especially the third (middle) metatarsal bone and third (middle) toe. This provides the greatest proximity to the region of the foot where the curvature (especially the concave curvature) occurs when the toes are correctly pointed. For example, the detector may be located between the material of the dance shoe and an inner lining material in the region of the shoe in which the metatarsal bones and the toes (especially the third metatarsal bone and third toe) of a wearer are located, such as by being sewn to the inner lining at the appropriate location.

As the skilled person would appreciate, the dance shoe of the present invention may comprise any suitable detector, which detector may detect a curvature (especially a concave curvature) of an area of the dance shoe. The detector of the dance shoe of the present invention does not need to contact a surface, such as the floor, in order to detect the desired configuration.

A suitable detector may comprise a passive device or an electrically powered device.

A detector may, for example, comprise a device that comprises means to produce a change in an electrical characteristic of a component, such as electrical resistance, voltage, current, capacitance and/or impedance, upon a curving (especially a concave curving) of the dance shoe. Such a device detects the curvature of the shoe by producing and detecting a change in a particular electrical characteristic of the component and a predefined configuration (such as a curvature, especially a concave curvature) may be indicated by the production and detection of a particular electrical characteristic of the component. As discussed below, the change in electrical characteristic may then be communicated to the signal means, which signal means generates a signal upon detection of the particular electrical characteristic.

A suitable device that comprises means to produce a change in electrical resistance is described as a bend sensor in U.S. Pat. No. 5,338,891. The bend sensor comprises a pair of resistive elements of a U-shape disposed on front and rear surfaces of a flexible substrate (such as a substrate comprised of a flexible plastics material). Upon flexing, the resistive elements vary their resistance values and the resistance variation may be detected through lead wires in the form of a voltage signal. Further details of the bend sensor are provided in U.S. Pat. No. 5,338,891.

Other suitable devices that comprise means to produce a change in electrical characteristics may act in response to a change in light intensity detected by a photosensitive detector or phototransistor. In other words, the device may act by causing a change in the light detected at a photosensitive detector or phototransistor as the curvature of the device changes. Examples of such devices are described in U.S. Pat. No. 4,937,444 and U.S. Pat. No. 6,940,062.

For example, U.S. Pat. No. 4,937,444 describes an optical flex sensor comprising an open ended flexible tube having a reflective interior wall. The tube comprises a light source positioned within the tube at one end and a photosensitive detector or light-transmitting device positioned within the tube at the other end. When the tube is straight, substantially all of the light emitted from the light source strikes the photosensitive detector, but when the tube is flexed or bent, a combination of direct light rays and reflected rays is detected by the photosensitive detector. The amount of light reaching the photosensitive detector decreases as the degree of flexing or bending of the tube is increased. The photosensitive detector changes its resistance with the change in light intensity, such that the optical flex detector changes its electrical resistance when flexed. The resistance variation may be detected in the form of a voltage signal. Further details of the optical flex sensor are provided in U.S. Pat. No. 4,937,444.

U.S. Pat. No. 6,940,062 describes an optical fiber curvature sensor comprising a light source, an optical fiber including a cut-out groove in the clad to improve sensitivity and detect curving (including curving direction), a light receiving element for measuring the intensity of light transmitting through the optical fiber (such as a phototransistor) and connectors for connecting the light source and the light receiving element to the optical fiber. Upon curving of the optical fiber, the amount of light transmitted from the light source to the light receiving element increases or decreases (depending on the arrangement of the cut-out groove in the fiber and the direction of the bending) and the change in light transmitted is translated into a change in electrical characteristics. Further details of the optical curvature sensor are provided in U.S. Pat. No. 6,940,062.

Another suitable device that comprises means to produce a change in electrical characteristic(s) may comprise at least two electric plates arranged such that a change in the capacitance or impedance between the plates occurs as the device is curved. In other words, the device produces a change in capacitance or impedance upon curving and a predefined configuration or curvature is associated with a predetermined capacitance or impedance.

A detector may comprise a device located in the dance shoe comprising an electric switch arranged such that the switch moves from being open or closed at a particular curvature to being closed or open at another particular curvature. For example, the switch may be open when the device is flat and closed so as to complete an electrical circuit when the device is curved at a predefined curvature. By closing the electric switch and completing the electrical circuit, the device may provide electrical power to the signal means.

A suitable detector may comprise a potentiometer, especially a flexible potentiometer. In particular the potentiometer (especially the flexible potentiometer) may be arranged to provide a consistent and variable electrical output upon bending or curving between different configurations. Thus, the detector provides a particular electrical output when the dance shoe is in the predefined configuration. Details of such a potentiometer are provided for example in U.S. Pat. No. 5,157,372.

As the skilled person would appreciate, a potentiometer is an electrical device that has an adjustable resistance. The potentiometer should be flexible or bendable so as to allow for the curving or bending of the dance shoe to which it is attached. The potentiometer typically detects a bending or curving in one direction only, for example by providing a change in resistance upon a bending or curving in one direction only.

A suitable flexible potentiometer may comprise a deflectable substrate, a conductor means and a connector means. The conductor means and the connector means typically may be provided on the deflectable substrate. Thus, the deflectable substrate may act as a support for the conductor means and the connector means. Any suitable substrate may be used, provided that it is flexible/deflectable. For example, the substrate may be formed of a deflectable and electrically insulating material. Preferably, the substrate is elastically deflectable. Suitable deflectable electrically insulating materials include various types of phenolic resin materials. For example, a phenolic resin Formula 3609 manufactured by Electronic Materials Corporation of America (EMCA-OREMEX Products, Ablestik Electronic Materials & Adhesives) has been found to be suitable in that it is elastically flexible or bendable for many thousands of cycles or bends and also is an electrical insulator. Further suitable deflectable electrically insulating materials include (but are not limited to) nylon, Mylar, polyamide, polyvinylchloride and polyvinylacetate. The substrate typically is elastically deflectable and typically has a thickness in the range of from about 0.01 to about 1.0 mm. As the skilled person would appreciate, the detector itself typically curves and/or bends, for example by means of the deflectable substrate, upon the curvature and/or bending of the shoe on which the detector is located. Additionally, the components provided on the substrate (such as the conductor means and the connector means) also should be capable of deflecting with the substrate.

Typically the substrate is of a length that substantially corresponds to the length of the foot extending from the metatarsus to the distal phalanges of a wearer of the dance shoe. This ensures that the curvature and/or bending of this region of the foot may be fully detected. For example, a dance shoe may have an upper front region of a length of from about 4 to 6 cm and the detector may comprise a substrate having a length of from about 2 to 6 cm, particularly of from about 2 to 3 cm, for example of about 2.5 cm.

The conductor means may be formed of an electrically conductive ink applied to the substrate and which predictably changes electrical resistance upon deflection of the substrate between a first configuration and a second configuration. For example, the electrically conductive ink may be adhered to the substrate in a pre-selected pattern. The particular resistance provided by the conductor means may be determined by the selection of a particular electrically conductive ink, the pattern in which the ink is applied to the substrate and/or the length and/or thickness of the ink applied to the substrate. This is turn allows for a conductor means/detector to be provided which may be capable of accurately and consistently detecting the predefined configuration as discussed herein.

Any suitable electrically conductive ink may be used. Preferably, the electrically conductive ink is a type which is applied to the substrate in liquid form and which dries to a solid form.

Preferably, the electrically conductive ink is adhered to the substrate. By adhere we mean that the conductive ink is attached to the substrate, for example by means of the conductive ink including a material which facilitates wetting, gluing and/or sticking A suitable conductive ink is available from Vintage Capital Corporation, 140 South Chapparal Court, Suite 110, Anaheim, Calif. 92808, and is identified as Formula or Model GL 71448. The conductive ink may include graphite in combination with a binder. Any suitable thickness of conductive ink may be used, with typical thicknesses being in the range of from about 0.01 mm to 1 mm, preferably about 0.05 mm. Any suitable length of conductive ink may be used, for example the length may be in the range of about 2 to 3 cm, for example of about 2.5 cm.

The connector means may be associated with the conductor means for interconnection to external electrical components (such as to a means of communication, for example a comparator and/or microcontroller, and/or to a signal means). Any suitable connector means may be used, as would be well known to a person skilled in the art.

The flexible potentiometer may comprise a segmented conductor adhered to the conductor means. The segmented conductor may be formed of an electrically conductive material in segments each spaced from the other along the conductor means. Typically, the segmented conductor may be of the type which is applied to the conductor means in liquid form and which dries to a solid form. Alternatively, the segmented conductor may be a solid which is pressed onto the conductor means.

The substrate typically has a length with a longitudinal axis. The conductor means may be provided in the form of a circuit having a first leg and a second leg each extending along the length of the substrate. A third leg may interconnect the first leg with the second leg. The first and second legs may be substantially parallel to the longitudinal axis.

The segmented conductor may include a plurality of segments, each having a width substantially the width of the conductor means and a length selected to regulate the electrical resistance of the conductor means. A segmented conductor may be made of a soft conductive metal, such as silver or a silver alloy. It may also be made of carbon or a carbon compound. Each segment may have a length of from about 2 mm to about 10 mm.

The dance shoe may further comprise a means for communication between the detector and the signal means. Any suitable means for communication may be provided, for example the means for communication may take the form of an integrated circuit. For example, the means for communication may comprise a means for reading and comparing outputs (such as outputs of electrical characteristics, for example voltages) from the detector and for determining when a desired output has been obtained. For example, the means for communication may comprise a comparator and a control means, such as a microcontroller. As the skilled person would appreciate, a comparator compares an output from the detector (for example the conductor means), which output may be a voltage, against a threshold value and provides a signal, for example to the control means (for example the microcontroller) when the threshold has been reached. The means for communication may further comprise connector means, for example for interconnection to external electrical components, such as the detector and/or the signal means. Any suitable connector may be used, as would be well known to a person skilled in the art.

In particular, the detector and the means for communication may be provided as an integral or one-piece unit. In other words, the detector and the means for communication may be provided on a single substrate for location at a suitable area of the dance shoe.

Preferably, the detector comprises a deflectable substrate, a conductor means and a connector means as discussed above and the means for communication comprises a comparator, a microcontroller and a connector means as discussed above, such that the conductor means, connector means, comparator and microcontroller are all located on the deflectable substrate, i.e. as an integral or one-piece unit for location at a suitable area of the dance shoe.

In use, power is supplied (from a suitable power supply) to the microcontroller, which in turn provides power to the comparator and the detector (for example the conductor means). The power may be supplied continuously, but is more preferably supplied for a set time interval (such as a time interval in the region of about 1×10⁻³ seconds or less) at a suitable time interval (such as from every 0.1 to 2 seconds, particularly every 1 second). The comparator checks for an output from the detector (for example a voltage output) and if there is movement of the detector (i.e. of the substrate and therefore of the conductor means), then there is a change in electrical resistance and therefore voltage. If the comparator identifies a particular voltage (i.e. above a set threshold), indicative of the predefined configuration, then a signal is sent and input to the microcontroller. When the microcontroller receives an input from the comparator, the microcontroller provides power to the signal means and a suitable signal is provided. For example, when the signal means is a visual signal, the microcontroller may provide power to one or more light emitting diodes, which light up as appropriate. The power is supplied to the signal means until the input to the microcontroller from the comparator ceases, i.e. because the electrical resistance and configuration of the dance shoe has changed and no longer corresponds to the predefined configuration.

As the skilled person would appreciate, the comparator may comprise an integrated circuit. The comparator typically compares the output of the detector against a reference or threshold value, which value may be set by one or more (for example two) fixed resistors. Suitable fixed resistors may be selected by a person skilled in the art according to the particular detector (or conductor means) in use. In other words, a calibration step may be conducted according to a particular detector, for example to determined the appropriate reference or threshold value.

The means for communication preferably further comprises a timer, which determines when the microcontroller should be fully operating. The microcontroller typically enters a sleep mode whenever it is not required to be fully operating, so as to save power. Similarly, other components of the detector, such as the comparator, are not powered when the microcontroller is in sleep mode.

An alternative detector may, for example, be arranged so as to produce a change in a non-electrical characteristic upon a curving of the dance shoe. For example, the detector may comprise a pleat or fold located in a top surface of the shoe in use, such that the pleat or fold is substantially closed when the shoe is flat (for example when, in use, the dancer wears the shoe and the toes are flat and not pointed) and the pleat or fold opens when the shoe is curved (for example when, in use, the dance wears the shoes and points the toes so as to arch or curve the foot). The degree of opening of the pleat or fold is dependent on the degree of curvature of the shoe. Thus, a concave curvature may be detected by the degree of opening of the pleat or fold and the predefined configuration may be defined by a predetermined opening of the pleat or fold. The pleat or fold may be located in the material from which the shoe is made.

A detector may comprise a pleat or fold located in an underside of the shoe in use, such that the pleat or fold is open when the shoe is flat (for example when, in use, the dancer wears the shoe and the toes are flat and not pointed) and the pleat or fold closes when the shoe is curved (for example when, in use, the dance wears the shoes and points the toes so as to arch or curve the foot). The degree of closing of the pleat or fold is dependent on the degree of curvature of the shoe. Thus, a concave curvature may be detected by the degree of closing of the pleat or fold and the predefined configuration may be defined by a predetermined closing of the pleat or fold. The pleat or fold may be located in the material from which the shoe is made. However, as the skilled person would appreciate, it is advantageous to locate any such detector in a top surface of the shoe in use, as it can then be readily observed during dancing. As the skilled person would appreciate, a combination of different detectors as described herein may be employed in the present invention.

The dance shoe may comprise a plurality of detectors, with each detector detecting a different configuration or curvature of the shoe in use. For example, the dance shoe may comprise two detectors, such as a first and a second detector for detecting first and second configurations or curvatures.

A suitable detector may be arranged and constructed so as to be capable of detecting more than one configuration (such as two configurations) of the dance shoe in use. For example, the dance shoe may comprise a detector arranged and constructed so as to detect first and second configurations in use. The detection of more than one configuration, such as first and second configurations, is advantageous because it allows the detection of more than one position or configuration of the foot in use.

The dance shoe of the present invention comprises a signal means operably associated with the detector so as to generate a signal upon detection of a predefined position or configuration by the detector, wherein the predefined configuration is provided by a curvature (especially a concave curvature) of an area of the dance shoe as described above.

In particular, the dance shoe of the present invention comprises a signal means operably associated with the detector so as to generate a signal upon detection of a predefined configuration by the detector, wherein the predefined configuration is provided by a curvature (especially a concave curvature) of an area of the dance shoe. As discussed above, the predefined configuration is provided by a curvature (especially a concave curvature) of an area of the foot such as is required by a dancer to attain the correct foot position to achieve the desired pointing of the toes. In particular, the predefined configuration may be detected in the region of the metatarsus (especially of the third metatarsal bone), and especially should continue to the ends of the toes.

By the term “operably associated”, we mean that the signal means is in communication with the detector so as to produce the signal only when the detector has detected the predefined position or configuration (for example curvature, especially concave curvature) in the dance shoe.

For example, when a detector acts to produce a change in electrical characteristic(s), an electrical signal may be communicated to the signal means, which signal means generates a signal upon detection of the particular electrical characteristic. For example, the electrical signal may be communicated to the signal means by means of an integrated circuit as described above.

When a detector acts to produce a change in non-electrical characteristic(s), a non-electrical change is communicated to the signal means, such as by an opening or closing of a pleat or fold as discussed above.

As discussed above, the signal means may be located at any suitable position in the dance shoe. For example, the signal means may be located in the sole of the shoe, but is preferably located in a side or upper surface and/or section of the shoe (i.e. a shoe upper) when worn. The signal means may be located in a side or upper surface and/or section of the shoe (i.e. a shoe upper) when worn in the region of the toes. In other words, the signal means preferably may be located in the shoe upper, more preferably in the front region of the shoe upper.

As the skilled person would appreciate, the dance shoe of the present invention may comprise any suitable signal means. For example, the signal means may generate a visual, audio or audiovisual signal (especially a visual signal).

When the signal means produces a visual signal, the visual signal may be generated in the form of a color and/or light that may be visible to the dancer and/or to a person observing the dancer. For example, a visual signal means may comprise one or more light means, such as one or more light emitting diodes, that emit a light (such as a colored light) upon detection of the predefined position or configuration, such as curvature (especially concave curvature). A visual signal means may alternatively comprise a colored material or cloth which is exposed upon detection of the predefined position or configuration, such as curvature (especially concave curvature), which may occur by means of the opening or closing of a pleat or fold as described above.

A visual signal means may conveniently be located in a side or upper surface and/or section of the shoe (i.e. a shoe upper) when worn in the region of the toes of a wearer, for example dancer. In other words, a visual signal means preferably may be located in the shoe upper, more preferably in the front region of the shoe upper. This may enable the dancer to observe the visual signal means, for example when the dancer is taking part in an exercise that requires the dancer to sit on the floor and point the toes until the correct position is achieved. In such an exercise, the dancer would know when the correct position was achieved whenever the visual signal is observed.

In particular, a visual signal means may comprise one or more light emitting diodes located in the front region of the shoe upper, for example in the region of the toes of a wearer of the shoe. For example, the light emitting diodes may be attached (for example adhered or sewn) to the material of the shoe in the front region of the shoe upper, for example in the region of the toes, such that they project outwards from the material at the desired location.

When the signal means produces an audio signal, the audio signal may be generated by the production of any suitable sound audible to the dancer and/or to a person observing the dancer. For example, an audio signal means may comprise one or more sound emitting devices (such as one or more buzzers or bells) that emit a sound upon detection of the predefined position or configuration, such as curvature (especially concave curvature).

When the signal means produces an audiovisual signal, the audiovisual signal may be generated in the form of a color and/or light which may be visible to the dancer and/or to a person observing the dancer and in the form of a suitable sound audible to the dancer and/or to a person observing the dancer. For example, an audiovisual signal means may comprise one or more light emitting diodes which emit a light (such as a colored light) upon detection of the predefined position or configuration, such as curvature (especially concave curvature), as well as one or more sound emitting devices (such as one or more buzzers or bells) which emit a sound upon detection of the predefined position or configuration, such as curvature (especially concave curvature). In other words, in this aspect, both a visual and an audio signal are generated upon detection of the predefined position or configuration, such as curvature (especially concave curvature).

In particular, the signal means may generate a visual signal, for example generated in the form of a color and/or light that may be visible to the dancer and/or to a person observing the dancer. For example, a visual signal means may comprise one or more light means, such as one or more light emitting diodes, that emit a light (such as a colored light) upon detection of the predefined position or configuration, such as curvature (especially concave curvature).

The signal means may generate a wireless signal detectable by a monitoring system. Typically, the monitoring system may generate a visual, audio or audiovisual signal upon detection of the wireless signal, which visual, audio or audiovisual signal preferably is visible to the dancer and/or to a person observing the dancer. Thus, the monitoring system may comprise a display screen and/or an audio means. In this case the signal that acts to indicate that the predefined position or configuration, such as curvature (especially concave curvature), has been attained is not necessarily provided at a location in the dance shoe itself and may, for example, be provided at a location remote from the dance shoe. For example, the signal may be provided at a display screen positioned in a dance studio at a location visible to the dancer and/or to a person observing the dancer, such as a dance teacher. This may be advantageous, as the visual, audio or audiovisual signal will be easily observed and/or heard during dancing, for example by both the dancer and any number of people observing the dancer.

As the skilled person would appreciate, a combination of different signal means as described herein may be employed in the present invention.

When the dance shoe comprises more than one signal means, each signal means may be operably associated with the same or different detectors. For example, when the dance shoe comprises a plurality of detectors, each detector may be operably associated with the same or different signal means. When the dance shoe comprises only one detector, the detector may be operably associated with one or more signal means.

The dance shoe may, for example, comprise a signal means that generates a wireless signal detectable by a monitoring system as well as a signal means that generates a visual, audio or audiovisual signal. In this case, the signal may be observed both on the dance shoe and on the monitoring system. The signal means that generates the wireless signal and the signal means that generates a visual, audio or audiovisual signal may each be operably associated with the same or different detectors. The dance shoe may further comprise a power supply for the detector and/or the signal means (and further optional components), as required by the particular detector and/or signal means (and further optional components) selected. The dance shoe may further comprise a power supply for the means for communication, as appropriate. Any suitable power supply may-be used, which power supply should be of a suitable size and weight for including in a dance shoe whilst causing little or no discomfort to the dancer in use of the shoe. For example, suitable power supplies include disc or button batteries. The power supply may comprise a rechargeable power supply.

The power supply may be located at any suitable location in the dance shoe, so as not to affect the feel of the shoe and/or the ease of movement of the dancer. The power supply preferably is located in the dance shoe so that it can readily be removed and replaced, as necessary. For example, the power supply may be located in a seam (such as a side seam) or cutout of the shoe. Preferably, the power supply is not located on the sole (or underside section) of the dance shoe. The power supply preferably is located in a side or top section of the dance shoe in use. In other words, the power supply preferably is located in the shoe upper, for example in the front region of the shoe upper. A cut out in the dance shoe in which the power supply is located may be covered by a design, such as a star or diamond shape design.

The detector, means for communication and a suitable power supply may be provided as an integral or one-piece unit for location in the dance shoe.

The detector may comprise a conductor means and a connector means and the means for communication may comprise a comparator, a microcontroller and a connector means as described above, wherein the conductor means, connector means, comparator and microcontroller and a suitable power supply are located on a deflectable substrate as an integral or one-piece unit. The aforementioned components may be attached to the substrate by any suitable means, such as by being adhered or sewn onto the substrate.

Furthermore, the detector, means for communication, signal means and a suitable power supply may be provided as an integral or one-piece unit for location in the dance shoe.

The detector may comprise a conductor means and a connector means, the means for communication may comprise a comparator, a microcontroller and a connector means and the signal means may comprise a visual signal means (such as one or more light emitting diodes) as described above, wherein the conductor means, connector means, comparator, microcontroller and visual signal means and a suitable power supply are located on a deflectable substrate as an integral or one-piece unit. The aforementioned components may be attached to the substrate by any suitable means, such as by being adhered or sewn onto the substrate.

Preferably, the dance shoe comprises a power supply and the detector comprises a deflectable substrate, a conductor means and a connector means as discussed above and the means for communication comprises a comparator and a microcontroller as discussed above, such that the power supply, the conductor means, the connector means, the comparator and the microcontroller are all located on the deflectable substrate, i.e. as an integral or one-piece unit for location in the dance shoe at a suitable location. The integral or one-piece unit may additionally comprise the signal means, such as a visual signal means (for example one or more light emitting diodes).

For example, the integral or one-piece units as described herein typically are provided as a flexible printed circuit board (i.e. a flexible PCB).

An integral/one-piece unit or flexible printed circuit board may include a fold along its width or length (particularly its length) to aid with its attachment to the dance shoe and/or to aid with the bending or stretching of the unit or board (and the components thereon) in use of the dance shoe.

The dance shoe of the present invention may further comprise an adjustment means for adjusting the sensitivity of the detector so as to enable a user to determine the point at which the predefined position or configuration is reached.

According to one aspect of the present invention, there is provided a dance shoe comprising:

(i) a detector for detecting a configuration of the dance shoe;

(ii) a signal means operably associated with the detector so as to generate a signal upon detection of a predefined configuration by the detector; and

(iii) a means for communication between the detector and the signal means; wherein the predefined configuration is provided by a curvature of an area of the dance shoe. The predefined configuration may be provided by a concave curvature of the area of the dance shoe.

In particular, in this aspect of the present invention, the detector may comprise a flexible potentiometer arranged to provide a consistent and variable electrical output upon bending between different configurations (for example comprising a deflectable substrate, a conductor means and a connector means) and the means for communication may comprise a comparator and a microcontroller, as discussed above. Even more particularly, the conductor means, the connector means, the comparator and the microcontroller may all be located on the deflectable substrate, for example as an integral or one-piece unit. Preferably, the dance shoe further comprises a power supply, which may be located on the deflectable substrate in addition to the conductor means, the connector means, the comparator and the microcontroller. The signal means (such as a visual signal means, for example one or more light emitting diodes) may further be located on the deflectable substrate.

The present invention further provides a method of detecting and signalling a predefined configuration of a dance shoe during dancing, the method comprising:

(i) detecting a configuration of the dance shoe; and

(ii) generating a signal upon detection of the predefined configuration, wherein the predefined configuration is provided by a curvature of an area of the dance shoe.

In the method of the present invention, the predefined configuration may be provided by a concave curvature of the area of the dance shoe as discussed above.

In the method of the present invention, the area of the curvature of the dance shoe may be located in a region of one or more of the metatarsal bones of a foot of a wearer, especially in the region of the third metatarsal bone of the foot of the wearer, as discussed above. More particularly, the area of the curvature may be located in a region of the dance shoe that is curved or bent upon the pointing of the toes of a wearer, for example the area of the curvature may be located in a region of the shoe which covers one or more of the metatarsal bones and continues to the very ends of the toes of a foot of a wearer, especially in the region of the third (middle) metatarsal bone to the very end of the third (middle) toe of the foot of the wearer.

Step (i) of the method of the present invention may comprise detecting a position or configuration of the dance shoe by a detector located in the dance shoe. Suitable detectors are as defined above. The detector may be located in the front region of the shoe upper, particularly in a central region of the front region of the shoe upper, as discussed above. This region of the shoe upper may correspond to the region of the shoe which covers one or more of the metatarsal bones of a foot of a wearer, especially the third (middle) metatarsal bone, and continues to the very end of the toes, especially the third (middle) toe, of the foot of the wearer. In other words, the detector may be located in the region of the shoe which covers one or more of the metatarsal bones of a foot of a wearer, especially the third (middle) metatarsal bone, and continues to the distal phalanges, especially the third (middle) distal phalanges, of the foot of the wearer.

Step (ii) of the method of the present invention may comprise generating any suitable signal, such as a visual, audio or audiovisual signal, especially a visual signal.

Step (ii) of the method of the present invention may comprise generating a wireless signal, which wireless signal is detectable by a monitoring system.

Examples of suitable visual, audio, audiovisual and wireless signals, as well as suitable monitoring systems, are discussed above.

In the method of the present invention, the dance shoe is preferably a soft-soled and/or soft-toed dance shoe, such as a ballet shoe, a jazz shoe, a soft-toed Irish dance shoe or a gymnastic shoe, especially a ballet shoe, as discussed above.

The present invention further provides the use of a detector in a dance shoe for detecting a predefined configuration of the dance shoe, wherein the predefined configuration is provided by a curvature of an area of the dance shoe. Suitable detectors are discussed above. The dance shoe is preferably a soft-soled and/or soft-toed dance shoe, such as a ballet shoe, a jazz shoe, a soft-toed Irish dance shoe or a gymnastic shoe, especially a ballet shoe, as discussed above.

The present invention further provides the use of a signal means in a dance shoe for producing a signal upon detection of a predefined configuration of the dance shoe, wherein the predefined configuration is provided by a curvature of an area of the dance shoe. The signal may be any suitable signal, such as a visual, audio or audiovisual signal (especially a visual signal), and/or the signal may be a wireless signal detectable by a monitoring system. Examples of suitable visual, audio, audiovisual signal and wireless signals, as well as suitable monitoring systems, are discussed above. The predefined position or configuration, such as curvature (especially concave curvature), may be detected by a detector located in the dance shoe. Suitable detectors are discussed above. The dance shoe is preferably a soft-soled and/or soft-toed dance shoe, such as a ballet shoe, a jazz shoe, a soft-toed Irish dance shoe or a gymnastic shoe, especially a ballet shoe, as discussed above.

The dance shoe, method and uses of the present invention may be used as a teaching aid, for example by a dance teacher teaching a dancer how to attain the desired position of the foot when pointing the toes and to help to strengthen the foot in the desired region.

In the uses of the present invention, the predefined configuration is provided by a curvature (especially a concave curvature) of an area of the dance shoe as discussed above.

The present invention further provides a system for detecting and signalling a predefined configuration of a dance shoe during dancing, the system comprising:

(i) a detector for detecting a configuration of the dance shoe; and

(ii) a signal means operably associated with the detector so as to generate a signal upon detection of a predefined configuration by the detector,

wherein the predefined configuration is provided by a curvature (especially a concave curvature) of an area of the dance shoe and the detector and signal means are suitably sized and arranged for location in the dance shoe.

The present invention further provides a system for detecting and signalling a predefined configuration of a dance shoe during dancing, the system comprising:

(i) a detector for detecting a configuration of the dance shoe;

(ii) a signal means operably associated with the detector so as to generate a wireless signal upon detection of a predefined configuration by the detector; and

(iii) a monitoring system for detecting the wireless signal and generating a visual, audio or audiovisual signal upon detection of the wireless signal,

wherein the predefined configuration is provided by a curvature (especially a concave curvature) of an area of the dance shoe and wherein the detector and signal means are suitably sized and arranged for location in the dance shoe.

The present invention further provides a kit for detecting and signalling a predefined configuration of a dance shoe during dancing, the kit comprising:

(i) at least one dance shoe;

(ii) a detector adapted for attachment to the dance shoe and for detecting a configuration of the dance shoe; and

(iii) a signal means adapted for attachment to the dance shoe and adapted for being operably associated with the detector so as to generate a signal upon detection of a predefined configuration by the detector, wherein the predefined configuration is provided by a curvature (especially a concave curvature) of an area of the dance shoe. The kit may further comprise a means for attaching the detector and a means for attaching the signal means to the dance shoe. For example, the detector and signal means may be provided on a single substrate, such as a flexible substrate in the form of a flexible printed circuit board, as discussed herein.

The present invention further provides a kit for detecting and signalling a predefined configuration of a dance shoe during dancing, the kit comprising:

(i) at least one dance shoe;

(ii) a detector adapted for attachment to the dance shoe and for detecting a configuration of the dance shoe; and

(iii) a signal means attached to the dance shoe and connectable to the detector so as to be operably associated with the detector and to generate a signal upon detection of a predefined configuration by the detector, wherein the predefined configuration is provided by a curvature (especially a concave curvature) of an area of the dance shoe. The kit may further comprise a means for attaching the detector to the dance shoe.

Examples of suitable detectors, signal means, visual, audio, audiovisual and wireless signals, as well as suitable monitoring systems, for use in the systems and kits of the present invention are discussed above.

The systems and kits of the present invention are suitable for use with any suitable dance shoe, preferably a soft-soled and/or soft-toed dance shoe, such as a ballet shoe, a jazz shoe, a soft-toed Irish dance shoe or a gymnastic shoe, especially a ballet shoe, as discussed above.

The aforementioned systems and kits of the present invention may be used as a teaching aid, for example by a dance teacher teaching a dancer how to attain the desired position of the foot when pointing the toes. The systems and kits may also be used to help to strengthen the foot of a dancer to help in attaining the desired position.

The means for attaching the detector and/or signal means to the dance shoe may comprise any suitable such means, such as a means for adhering or sewing the detector and/or signal means to the shoe. The kit may further comprise instructions for attaching the detector and/or signal means, for example including how and where the detector means and/or signal means should be attached.

As the skilled person would appreciate, either a pair of dance shoes or a single dance shoe may be provided according to the present invention.

The present invention will now be described by way of example only and with reference to the accompanying schematic drawings.

### BRIEF DESCRIPTION OF THE DRAWINGS

FIG. 1 shows a side view of a dance shoe in a first position according to one embodiment of the invention;

FIG. 2 shows a side view of the dance shoe of FIG. 1 in a second position;

FIG. 3 shows a side view of a dance shoe in a first position according to another embodiment of the invention;

FIG. 4 shows a side view of the dance shoe of FIG. 3 in a second position;

FIG. 5 shows a plan view of a dancer wearing a dance shoe according to the present invention in proximity to a monitoring system;

FIG. 6 shows a perspective view of a dance shoe according to another embodiment of the present invention;

FIG. 7 shows a perspective view of a top of the dance shoe of FIG. 6;

FIG. 8 shows a perspective view of an underside of a dance shoe of FIG. 6;

FIG. 9 shows a side plan view of the dance shoe of FIG. 6 in a first position;

FIG. 10 shows a side plan view of the dance shoe of FIG. 6 in a second position;

FIG. 11 shows a first side of a detector suitable for use in the dances shoes of FIGS. 1-10;

FIG. 12 shows a second side of the detector of FIG. 11;

FIG. 13 shows a third side of the detector of FIG. 11;

FIG. 14 shows a block diagram showing a suitable arrangement of the detector, means for communication, signal means and power supply for including in a dance shoe of the present invention;

FIG. 15 shows an example of a printed circuit board for including in a dance shoe of the present invention; and

FIG. 16 shows a circuit diagram corresponding to the printed circuit board shown in FIG. 15.

### DETAILED DESCRIPTION

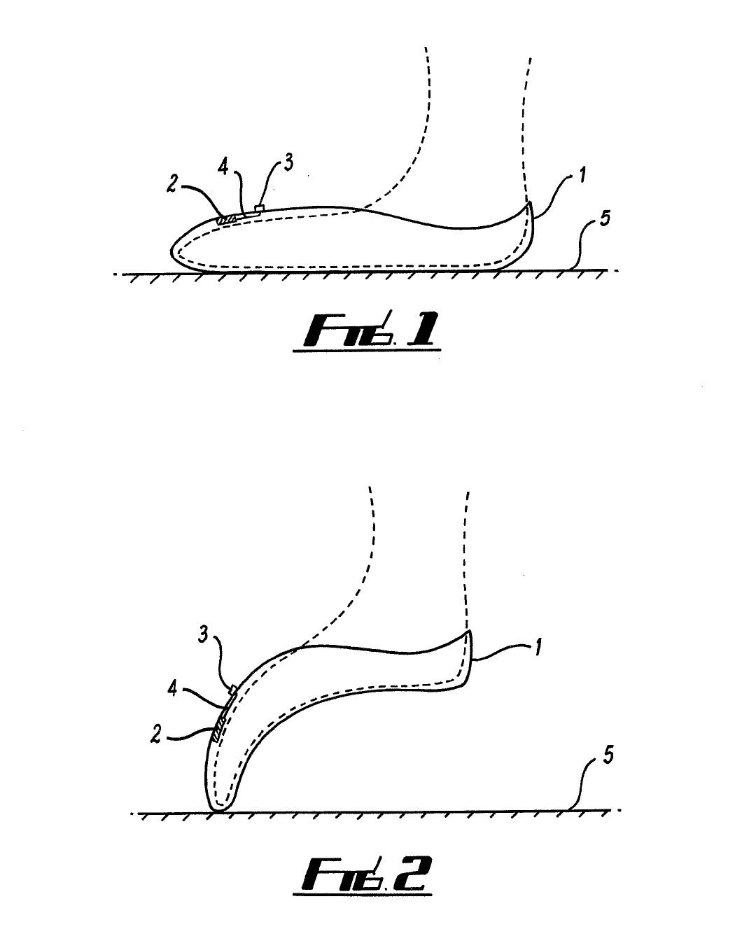

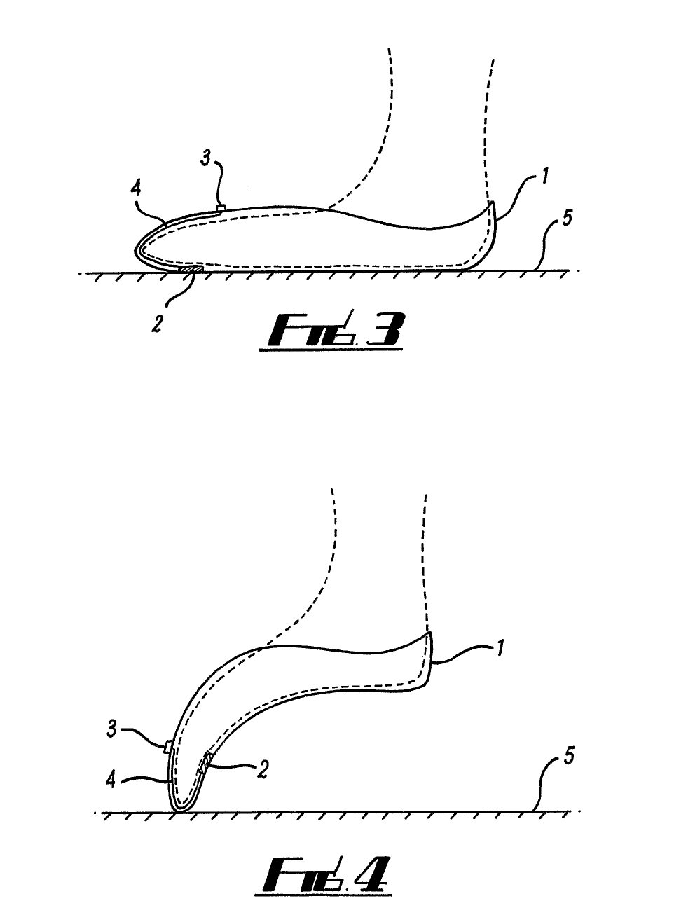

FIGS. 1 and 2 show a dance shoe (1) comprising a detector (2) and a signal means (3). In the dance shoe shown in FIGS. 1 and 2, the detector (2) is secured to an inner surface of an upper section of the dance shoe (1) and the signal means (3) is secured to an outer surface of an upper section of the dance shoe (1). However, as discussed above, the detector (2) and signal means (3) may be secured to any suitable location of the dance shoe and by any suitable means.

The dance shoe (1) shown in FIGS. 1 and 2 further comprises a means (4) for communication between the detector (2) and the signal means (3). Thus, in FIGS. 1 and 2, the detector (2) may be one that acts to produce a change in electrical characteristics as discussed above, wherein an electrical signal is communicated to the signal means (3) by a means (4) for communication which comprises an integrated circuit.

In FIG. 1, a dancer's foot is positioned in the dance shoe (1) (which foot is shown by the dashed lines) and the foot is flat on the ground (5). In other words, in FIG. 1 the dancer is not pointing the toes. In FIG. 2, the dancer is pointing the toes and the foot is arched or curved and the area of curvature is provided in an area that covers one or more of the metatarsal bones and continues to the very ends of the toes of a foot of a wearer, especially in the region of the third (middle) metatarsal bone to the very end of the third (middle) toe of the foot of the wearer. In use, this curvature is detected by the detector (2) and when a predefined curvature is detected, the signal means (3) generates a signal, such as a visual, audio, audiovisual or wireless signal, as discussed above.

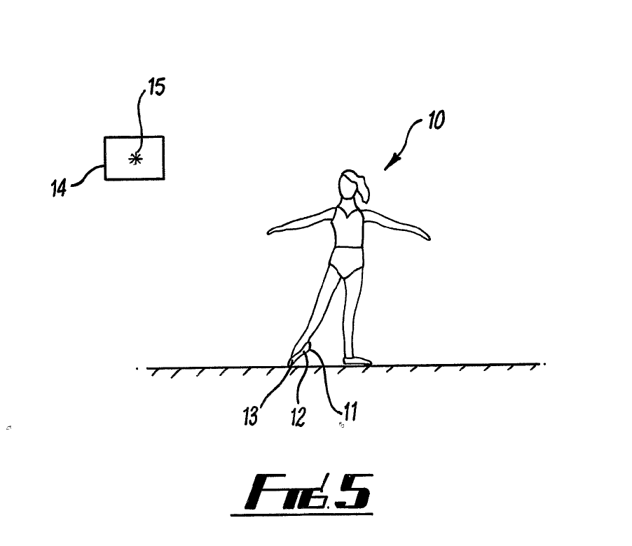

FIGS. 3 and 4 show a similar dance shoe (1) to FIGS. 1 and 2, comprising a detector (2) and a signal means (3). However, in the dance shoe shown in FIGS. 3 and 4, the detector (2) is secured to an inner surface of a lower section (for example an underfoot section or sole) of the dance shoe (1) in use and the signal means (3) is secured to an outer surface of an upper section of the dance shoe (1) in use. However, as discussed above, the detector (2) and signal means (3) may be secured to any suitable location of the dance shoe and by any suitable means.

The dance shoe (1) shown in FIGS. 3 and 4 further comprises a means (4) for communication between the detector (2) and the signal means (3). As for FIGS. 1 and 2, the means (4) for communication may comprise an integrated circuit.

In FIG. 3, a dancer's foot is positioned in the dance shoe (1) (which foot is shown by the dashed lines) and the foot is flat on the ground (5). In other words, in FIG. 3 the dancer is not pointing the toes. In FIG. 4, the dancer is pointing the toes and the underside of the foot is arched or curved (which curvature runs from the region of one or more of the metatarsal bones and continues to the very ends of the toes of a foot of a wearer, especially from the third (middle) metatarsal bone to the very end of the third (middle) toe of the foot of the wearer). This in turn causes a curvature in the dance shoe (1), as can be appreciated from FIG. 4. In use, the curvature is detected by the detector (2) and when a predefined curvature is detected, the signal means (3) generates a signal, such as a visual, audio, audiovisual or wireless signal, as discussed above.

FIG. 5 shows a dancer (10) wearing at least one dance shoe (11) according to the present invention, which dance shoe (11) comprises a detector (13) and a signal means (12). In FIG. 5, the signal means (12) acts to generate a wireless signal upon the dancer pointing the toes (and reaching the predefined configuration). The wireless signal is detected by a monitoring system, which is shown in FIG. 5 as a display screen (14). The display screen (14) displays a symbol (15) when the predefined configuration is detected. As shown in FIG. 5, the display screen is remote from the dance shoe (11) but can be observed by the dancer or by a person observing the dancer (such as a dance teacher) during dancing. As the skilled person would appreciate, the dance shoe (11) shown in FIG. 5 may further comprise additional signal means, for example signal means that generate a visual, audio or audiovisual signal and that are located in the dance shoe (11). The dance shoe (11) shown in FIG. 5 may further comprises a means for communication between the detector (13) and the signal means (12), as discussed above.

As the skilled person would appreciate, the dance shoes shown in FIGS. 1 to 5 also would comprise a suitable power supply (not shown) attached at a suitable location for supply of power to the electrical components.

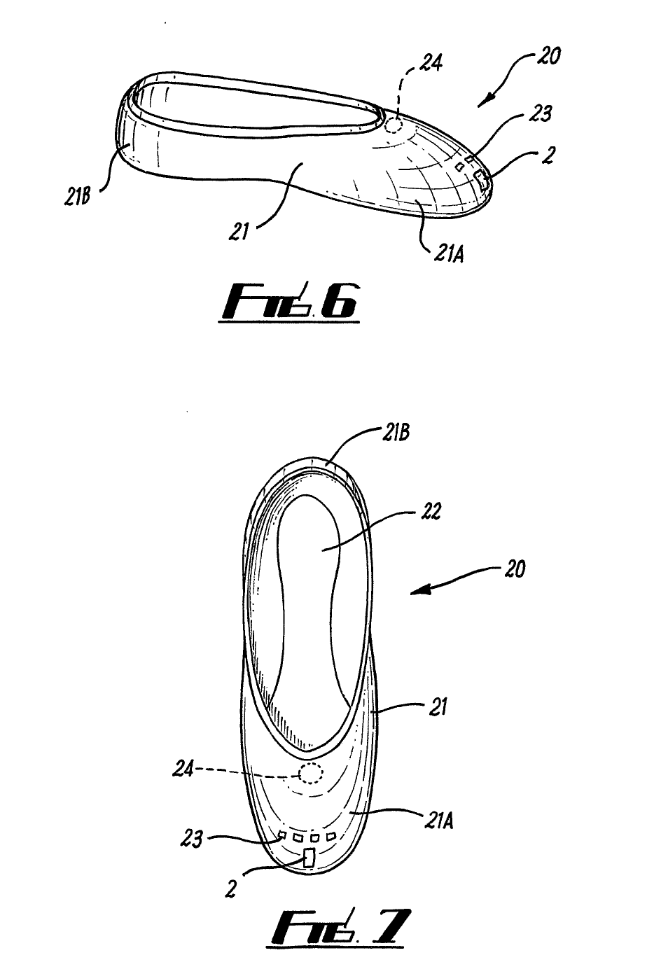

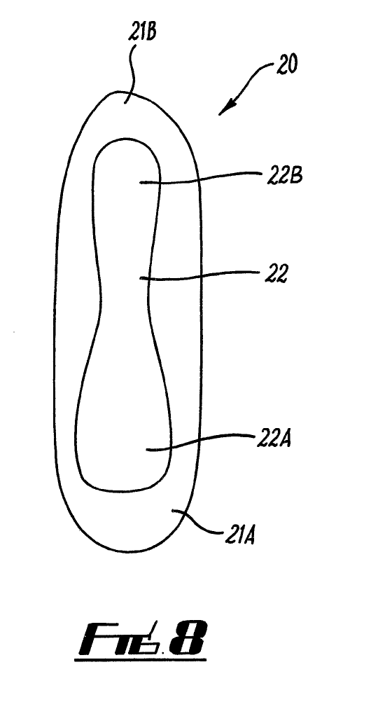

FIGS. 6 to 8 show in more detail the construction of a dance shoe, which may be provided in accordance with the present invention. The dance shoe shown in FIGS. 6 to 8 is a ballet shoe (20) of a full sole construction. The ballet shoe (20) comprises a shoe upper (21) arranged to cover the toes of a foot of a wearer and to extend along either side of the instep and around the heel. The shoe upper (21) comprises a front region (21A) and a rear region (21B). The front region (21A) of the shoe upper (21) is arranged to surround at least a portion of the front half of a foot of a wearer and surrounds the upper surface and sides of the toes and a front part of the foot (including the metatarsal bones and phalanges) of a wearer. The rear region (21B) of the shoe upper (21) is arranged to surround at least a portion of the rear half of a foot of a wearer and surrounds the heel of a wearer. The ballet shoe (20) further comprises an underfoot section (22), for example of a full sole construction as shown in FIGS. 7 and 8. However, as a skilled person would appreciate, the underfoot section (22) may also be of a split sole construction, as discussed above. The underfoot section (22) covers the underside of a foot of a wearer and comprises a front region (22A) and a rear region (22B). The front region (22A) of the underfoot section (22) extends under the front of a foot and is connected with the front region (21A) of the shoe upper (21). The rear region (22B) of the underfoot section (22) extends under the heel region of a foot and is connected with the rear region (21B) of the shoe upper (21).

As shown in FIGS. 6 and 7, a detector (2) is located in the shoe upper (21) in the front region (21A). More particularly, the detector (2) is located in a central portion of the front region (21A) of the shoe upper (21), so as to be located in an area of a foot of a wearer including one or more metatarsal bones and phalanges, as described in more detail above. In FIGS. 6 and 7, the detector is shown attached to an outer surface of the front region (21A) of the dance shoe. However, as discussed above, the detector may be attached to an outer or inner surface of the dance shoe, and preferably is attached to an inner surface.

As shown in FIGS. 6 and 7, a signal means (3) is located in the shoe upper (21) in the front region (21A). More particularly, one or more (for example four, as shown in FIG. 7) light emitting diodes (23) may be located in the front region (21A) of the shoe upper (21). In FIGS. 6 and 7, the light emitting diodes are shown attached to an outer surface of the front region (21A) of the shoe upper (21), which is preferred to allow for their observation, for example by a dancer wearing the shoe.

The dance shoe shown in FIGS. 6 to 8 further comprises a disc battery (24) (shown by dashed lines) located in a cut out portion of the front region (21A) of the shoe upper (21). The dance shoe further comprises suitable means for communication (for example comprising a comparator and microcontroller as discussed above) and connectors for connecting electrical components, although these are not shown in FIGS. 6 to 8.

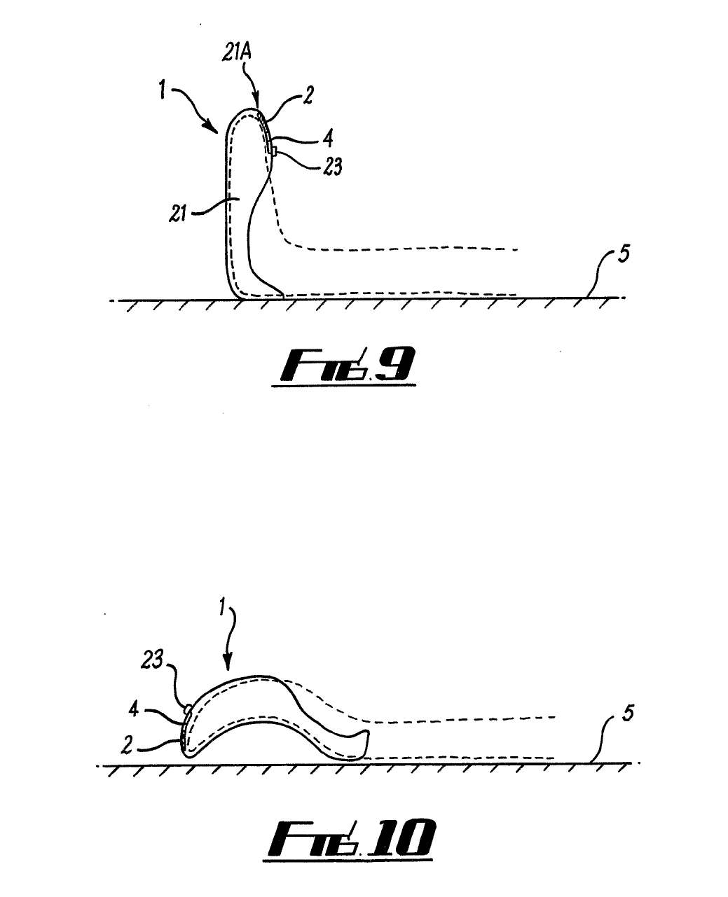

FIGS. 9 and 10 show a further dance shoe (1) of the present invention comprising a detector (2) and a signal means (3), wherein the signal means is a light emitting diode (23). In the dance shoe shown in FIGS. 9 and 10, the detector (2) is secured to an inner surface of the front region (21A) of the shoe upper (21) of the dance shoe (1), for example in the region of the metatarsophalangeal joint of a wearer (shown by dashed lines). The light emitting diode (23) is secured to and projects outwardly from an outer surface of the front region (21A) of the shoe upper (21) of the dance shoe (1).

The dance shoe (1) shown in FIGS. 9 and 10 further comprises a means (4) for communication between the detector (2) and the light emitting diode (23). Thus, in FIGS. 9 and 10, the detector (2) may be one that acts to produce a change in electrical characteristic(s) as discussed above, wherein an electrical signal is communicated to the light emitting diode (23) by a means (4) for communication which comprises an integrated circuit, for example comprising a comparator and a microcontroller as discussed above.

In FIG. 9, a dancer's foot is positioned in the dance shoe (1) (which foot is shown by the dashed lines) and the dancer is sitting on the ground (5) such that the foot is pointing upwards away from the ground (5) and the dancer is not pointing the toes. In FIG. 10, the dancer is pointing the toes and the foot in the region of one or more of the metatarsal bones to the very ends of the toes (especially in the region of the third (middle) metatarsal bone to the very end of the third (middle) toe) is arched or curved, i.e. so as to provide a concave curvature of the underside of the foot relative to the surface of the ground. This in turn causes a curvature of the underside of the region of the dance shoe (1) where the metatarsal bones and phalanges (particularly the middle metatarsal bone and phalanges) of the wearer are located, as can be appreciated from FIG. 10. In use, this curvature is detected by the detector (2) and when a predefined curvature is detected, the detector communicates with the signal means (3), via. the means for communication (4), and the light emitting diode (23) is lit.

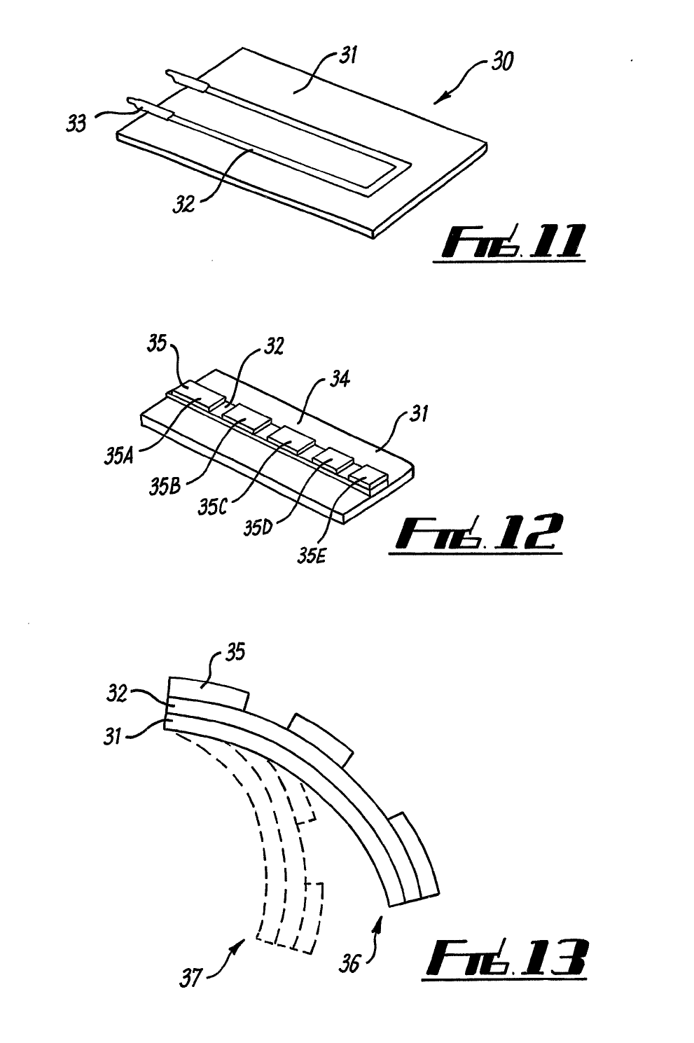

FIG. 11 shows a detector (30) suitable for use in a dance shoe according to the present invention, in the form of a flexible potentiometer. The flexible potentiometer shown in FIG. 11 comprises a substrate (31), a conductor means (32) and a connector means (33). The connector means (33) is associated with the conductor means (32) for interconnection to external electrical components, such as a means for communication and/or a signal means as described herein.

FIG. 12 shows a portion of the flexible potentiometer shown in FIG. 11. The substrate (31) shown in FIG. 12 has a top surface (34) to which the conductor means (32) is applied in a pre-selected pattern. For example, in FIG. 11, the pattern is “U-shaped” to present a particularly desired circuit. Other shapes may be desired to produce a variety of different electrical outputs upon deflection. The pre-selected pattern may typically be straight or linear, as illustrated in FIGS. 11 and 12. The U-shaped pattern is believed to be advantageous in the detector for use in the dance shoe of the present invention because it provides improved sensitivity, is convenient to manufacture and use, allows the use of a detector of the desired length in the dance shoe and allows the connector means to be positioned at one end of the conductor means, allowing for easy and convenient connections to other electrical components.

The conductor means (32) of FIG. 12 is formed of an electrically conductive ink which is adhered to the substrate (31). The electrically conductive ink predictably changes electrical resistance upon deflection or bending of the substrate (31) between a first configuration and a second configuration. The conductor means (32) may also be a two-part epoxy material, a thermoset adhesive, or a thermoplastic, all incorporating conductive material such as graphite.

The flexible potentiometer as shown in FIG. 12 includes a segmented conductor (35) adhered to the conductor means (32), although such a segmented conductor is not essential for use in the detector provided in the dance shoe of the present invention. The segmented conductor (35) may be formed of an electrically conductive material in segments (35A), (35B), (35C), (35D) and (35E) each spaced from the other along the conductor means (32). The segments may each be spaced apart a pre-selected distance, which may be substantially the same or different, as desired to detect the predefined configuration. The segments may be positioned on the conductive ink to regulate the conductivity and in turn the electrical resistance of the conductive ink As noted above, FIG. 12 shows only a portion of a flexible potentiometer and the length may be longer or shorter than shown.

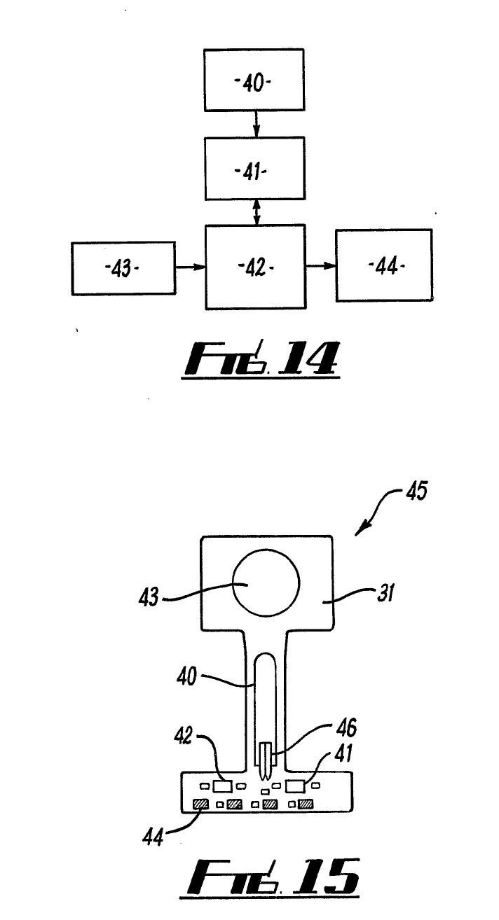

As shown in FIG. 13, the flexible potentiometer of FIG. 11, comprising a conductor means (32) with a segmented conductor (35) positioned on the substrate (31), is deflectable between a first configuration (36) illustrated with solid lines and a second configuration (37) illustrated with dotted lines. In other words, the substrate (31) is bendable or deflectable between the first configuration (36) and the second configuration (37). Upon deflection between the first configuration (36) and the second configuration (37), the electrical resistance as measured between the connectors (33) varies consistently and predictably. That is, the variance in electrical resistance is not only predictable or known for the various deflections or configurations but also the variance is consistent and does not radically or randomly change over the lifetime of the potentiometer. Thus, the substrate (31) can be repetitively deflected between the first configuration (36) and the second configuration (37), and the resistance will thereby consistently and predictably vary to reflect the deflection and the configuration. This enables the detector to consistently and accurately detect the predefined configuration.

Without wishing to be bound by any theory, it is believed that as the flexible potentiometer is deflected or bent, the dried conductive ink has a granular or crystalline-type structure which cracks or breaks upon deflection. As the conductive ink bends, the number of cracks and the space between them is believed to increase, thereby changing the electrical resistance in a predictable manner. The change can be measured upon application of suitable electrical signals.

FIG. 14 shows a block diagram representing a circuit for including in the dance shoe, i.e. comprising the detector, the signal means and the means for communication. As shown in FIG. 14, the circuit comprises a detector (40), connected to a comparator (41) in communication with a microcontroller (42). The microcontroller (42) is powered by a power source (43) (for example a battery), which in turn provides power to the comparator (41). The microcontroller (42) also is connected to the signal means, in the form of a light emitting diode (44), and provides power to the light emitting diode when a suitable signal is received from the comparator (41).

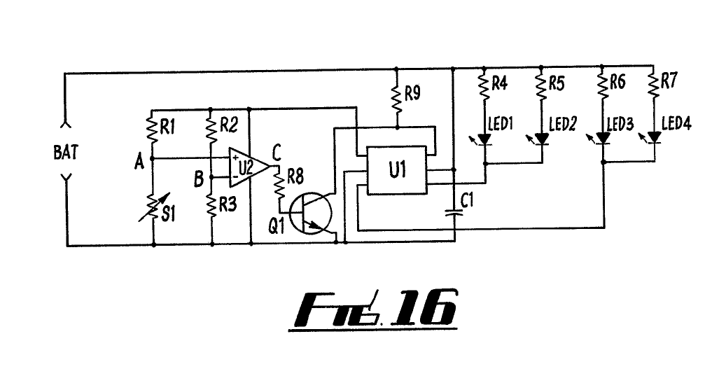

FIG. 15 shows an integral or one-piece unit (45), for example in the form of a flexible printed circuit board, for locating in a dance shoe of the present invention. The unit (45) comprises a flexible substrate (31) upon which is located a detector (40) comprising a conductor means (32) formed of an electrically conductive ink The conductor means (32) is connected, by means of connector means (46), to an integrated circuit including a comparator (41) and a microcontroller (42). The unit (45) further comprises a power source (43), for example a disc battery, for providing power to the electrical components. The unit (45) further comprises connector means (not shown) for connecting to the signal means, such as one or more light emitting diodes (44). The integral or one-piece unit (45) may by attached to a dance shoe by any suitable means and at any suitable location, for example in a central region of the front region (21A) of the shoe upper (21) as discussed above.

FIG. 16 shows a circuit diagram corresponding to the block diagram shown in FIG. 14. Referring to the circuit diagram as shown in FIG. 16, the operation is as follows. The flexible detector/sensor S1 and resistor R1 together form a potential divider. The voltage at point A will vary with the resistance of the detector/sensor S1. This will vary with the degree of bend of the detector/sensor. Point B is a reference voltage produced by potential divider R2 and R3. The voltage at point A is compared to the voltage at point B by the comparator U2. When the shoe is in the desired position/configuration, the voltage at point A will have passed the reference voltage of point B and the output of the comparator point C will turn on the transistor Q1 which in turn sends a signal to the microcontroller U1. When the microcontroller receives this signal it will cause the LEDs (LED1 to LED4) to flash in a random pattern to indicate to the wearer that the desired foot position has been attained. When the shoe is not in the desired position/configuration, the transistor will be turned off and the microcontroller will not receive a signal. The microcontroller will then turn the LEDs off and will also remove power from the comparator and the two potential dividers (R1, S1, R2 & R3). The microcontroller will then enter a sleep (power down) mode thus saving power.

When the microcontroller is in the sleep mode it will be woken up each second by its internal watchdog timer. On waking the microcontroller will apply power to the comparator and the two potential dividers and then look for a signal from Q1. If the signal is present the microcontroller will flash the LEDs as above. If the signal is not present the microcontroller will remove power from the comparator and the two potential dividers and then re-enter the sleep mode.

Power to the circuit is provided by a battery (BAT). The circuit is continually powered, no switch being necessary due to the very low power demand when the microcontroller is in sleep mode.

1. A dance shoe comprising:
a detector configured to detect a configuration of the dance shoe; and
a signal means operably associated with the detector so as to generate a signal upon detection of a predefined configuration by the detector;
wherein the predefined configuration is provided by a curvature of an area of the dance shoe.

2. The dance shoe of claim 1, wherein the predefined configuration is provided by a concave curvature of the area of the dance shoe.

3. The dance shoe of claim 1, wherein further comprising a shoe upper and an underfoot section, the shoe upper and the underfoot section each including a front region and a rear region, wherein the detector is located in the front region of the shoe upper.

4. The dance shoe of claim 3, wherein the detector is located in a central region of the front region of the shoe upper.

5. The dance shoe of claim 1, wherein the detector includes a device having means to produce a change in an electrical characteristic of a component upon the curvature of the dance shoe.

6. The dance shoe of claim 5, wherein the detector includes a flexible potentiometer.

7. The dance shoe of claim 6, wherein the potentiometer is arranged to provide a consistent and variable electrical output upon bending between different configurations.

8. The dance shoe of claim 6, wherein the potentiometer includes a deflectable substrate, a conductor means, and a connector means.

9. The dance shoe of claim 1, further comprising a means for communication between the detector and the signal means.

10. The dance shoe of claim 9, wherein the means for communication includes a comparator and a microcontroller.

11. The dance shoe of claim 10, wherein the detector and the means for communication are provided as an integral unit.

12. The dance shoe of claim 1, wherein the signal means generates one of a visual, audio, and audiovisual signal.

13. The dance shoe of claim 1, wherein the signal means generates a visual signal.

14. The dance shoe of claim 1, wherein the signal means generates a wireless signal detectable by a monitoring system.

15. The dance shoe of claim 1, further comprising a power supply for at least one of the detector and the signal means.

16. The dance shoe of claim 15, wherein the detector, the means for communication, and the power supply are provided as an integral unit.

17. The dance shoe of claim 1, wherein the dance shoe is a soft-toed dance shoe.

18. A method of detecting and signalling a predefined configuration of a dance shoe during dancing, the method comprising:
detecting a configuration of the dance shoe; and
generating a signal upon detection of the predefined configuration,
wherein the predefined configuration is provided by a curvature of an area of the dance shoe.

19. The method of claim 18, wherein the predefined configuration is provided by a concave curvature of the area of the dance shoe.

20. The method of claim 18, wherein the dance shoe includes a shoe upper and an underfoot section, the shoe upper and the underfoot section each having a front region and a rear region; and the method further comprising, providing a detector in the front region of the shoe upper.

21. The method of claim 20, further comprising, providing the detector in a central region of the front region of the shoe upper.

22. The method of claim 18, wherein generating the signal includes generating one of a visual, audio, and audiovisual signal.

23. The method of claim 18, wherein generating the signal includes generating a visual signal.

24. The method of claim 18, wherein generating the signal includes generating a wireless signal detectable by a monitoring system.

25. The method of claim 18, wherein the dance shoe is a soft-toed dance shoe.

26.-33. (canceled)

34. A kit for detecting and signalling a predefined configuration of a dance shoe during dancing, the kit comprising:
at least one dance shoe;
a detector adapted for attachment to the dance shoe and configured to detect a configuration of the dance shoe; and
a signal means adapted for attachment to the dance shoe and adapted for being operably associated with the detector so as to generate a signal upon detection of a predefined configuration by the detector, wherein the predefined configuration is provided by a curvature of an area of the dance shoe.

35. (canceled)
